(19) United States
(12) Patent Application Publication
(10) Pub. No.: US 2003/0072023 A1
(43) Pub. Date: Apr. 17, 2003

(54) Key operation monitoring method, drawing information obtaining method and key operation reproducing method in image forming apparatus

(76) Inventor: Hiroyuki Tanaka, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/259,322

(22) Filed: Sep. 30, 2002

(30) Foreign Application Priority Data
Sep. 28, 2001 (JP) 2001-304660
Sep. 27, 2002 (JP) 2002-283753

(51) Int. Cl. G06F 9/44; G06F 15/00; G06F 11/30

(52) U.S. Cl. 358/1.13; 717/124; 717/127; 358/1.14

(57) ABSTRACT

A key operation monitoring method used for monitoring a key operation input from an operation panel in an image forming apparatus is provided, in which the key operation monitoring method includes the steps of: obtaining the key operation as the key event information; and receiving the obtained key event information by interprocess communication.

### BACKGROUND OF THE INVENTION

1. Field of the Invention

The present invention relates to a method used for debugging an image forming apparatus that performs user services relating to image formation such as printing, copying or sending documents by facsimile. More particularly, the present invention relates to a key operation monitoring method for monitoring key operations from an operation panel, a drawing information obtaining method for obtaining drawing information for the operation panel, and a key operation reproducing method for reproducing key operations of the operation panel. In addition, the present invention relates to a program causing a computer to execute these methods, and to an image forming apparatus that can execute the key operation monitoring method, the drawing information obtaining method and the key operation reproducing method.

2. Description of the Related Art

Recently, an image forming apparatus (to be referred to as a compound machine hereinafter) that includes functions of a printer, a copier, a facsimile, a scanner and the like in a cabinet is generally known. The compound machine includes a display part, a printing part and an image pickup part and the like in a cabinet. In the compound machine, three pieces of software corresponding to the printer, copier and facsimile respectively are provided, so that the compound machine functions as the printer, the copier, the scanner and the facsimile respectively by switching the software.

The compound machine is configured such that it provides each of the user services of the printer, the copier, the facsimile and the scanner by pushing a key displayed as drawing data on the display part on the operation panel. Therefore, at the developing stage of the compound machine, it is important to debug the machine to operate properly according to key operations by a user.

However, according to a conventional compound machine, there is no function for debugging the machine to operate properly according to key operations from the operation panel. The conventional compound machine has a simple structure, that is, each function unit of software for the printer, the copier, the scanner and the facsimile is individually provided in the conventional compound machine. Therefore, even though operation check is not performed by monitoring key operations, quality can be maintained by debugging each piece of software individually.

Since the conventional compound machine is provided with each software for the printer, the copier, the scanner and the facsimile individually, much time is required for developing the software. Therefore, the applicant has developed an image forming apparatus (compound machine) including hardware resources, a plurality of applications, and a platform including various control services provided between the applications and the hardware resources. The hardware resources are used for an image forming process in a display part, a printing part and an image pickup part. The applications perform processes intrinsic for user services of printer, copier and facsimile and the like. The platform includes various control services performing management of hardware resource necessary for at least two applications commonly, execution control of the applications and image forming processes when a user service is executed.

Since the image forming apparatus includes the platform that performs management of hardware resources used by at least two applications commonly, and that performs execution control and image forming processes, software can be developed efficiently, so that productivity in the machine can be improved.

Since the compound machine has the control service that provides a service commonly used for at least two applications, and many pieces of software operate intricately intertwining with each other, there is a problem in that it is difficult to determine whether the compound machine properly operates according to key operations by a user even if debugging is performed only for each of the pieces of software. Especially, there is a problem in that, when a failure occurs while the machine operates on the basis of a key operation by a user, it is difficult to specify a failed piece of software, so that debugging for the compound machine requires enormous efforts.

### SUMMARY OF THE INVENTION

An object of the present invention is to provide a key operation monitoring method, a drawing information obtaining method, a key operation reproducing method for improving efficiency of debugging, and a program for causing a computer to execute the methods, and an image forming apparatus.

The above object can be achieved by a key operation monitoring method used for monitoring a key operation input from an operation panel in an image forming apparatus, the key operation monitoring method comprising: a key monitoring step of obtaining the key operation as key event information.

In the key operation monitoring method, the key monitoring step may includes the step of receiving key event information sent by a communication driver in the operation panel.

The key event information can be used for debugging. Thus, key operations at a time when a failure arises can be easily reproduced for example, so that debugging can be performed efficiently according to the present invention.

In addition, according to the present invention, key operation monitoring method is provided, in which the image forming apparatus may includes: hardware resources used for image forming processes; an application for performing a process specific for a user service; and a system control service for controlling the operation panel, the system control service being provided between the application and the hardware resources; and the key monitoring step for obtaining a key operation comprises the steps of:

obtaining the key operation as the key event information by the system control service; and

receiving the key event information from the system control service by using interprocess communication.

According to this method, the key event information can be easily obtained in the image forming apparatus in which a plurality of pieces of software operate by using interprocess communication, so that the key event information can be used for debugging. Thus, key operations at a time when a failure arises can be easily reproduced, so that debugging can be performed efficiently.

A drawing information obtaining method is also provided according to the present invention, in which the drawing information obtaining method is used for obtaining drawing information output to an operation panel in an image forming apparatus, the image forming apparatus comprising an application for providing a user service and the operation panel, the drawing information obtaining method includes: the drawing information obtaining step of receiving the drawing information from the application by using interprocess communication.

According to the above-mentioned method, information that is displayed on the operation panel (drawing information) can be obtained easily. Therefore, drawing information displayed on the operation panel at a time of failure can be easily reproduced, so that debugging for the image forming apparatus can be performed efficiently.

A key operation reproducing method can be also provided according to the present invention, in which the key operation reproducing method is used for reproducing a key operation input from an operation panel in an image forming apparatus, the image forming apparatus comprising an application for performing a user service and the operation panel, the key operation reproducing method includes the steps of: obtaining key history data from a storage that stores the key history data, the key history data including a plurality of pieces of key event information corresponding to key operations on the operation panel; generating reproduced information from the key history data; and sending the reproduced information to the application so as to reproduce a key operation.

Accordingly, a key operation can be automatically reproduced and execution result of the key operation can be easily evaluated, so that debugging and evaluation can be performed efficiently.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a compound machine according to a first embodiment of the present invention;

FIG. 2 shows a hardware configuration of the compound machine according to the first embodiment of the present invention;

FIG. 3 shows a block diagram of a key monitor according to the first embodiment of the present invention;

FIG. 4 shows a data structure of the message sent to the message queue in the compound machine according to the first embodiment of the present invention;

FIG. 5A shows a data structure of key event information stored in the message queue according to the first embodiment of the present invention;

FIG. 5B shows a data structure of the key event information after processed by the SCS data processing part according to the first embodiment of the present invention;

FIG. 6A shows a data structure of the drawing information stored in the message queue according to the first embodiment of the present invention;

FIG. 6B shows a data structure of the drawing information after processed by the OCS data processing part according to the first embodiment of the present invention;

FIG. 7 shows a data structure of a command stored in the message queue according to the first embodiment of the present invention;

FIG. 8A shows a data structure of each record of the history data according to the first embodiment of the present invention;

FIG. 8B shows a data structure of the generated reproduced information according to the first embodiment of the present invention;

FIG. 9 is a flowchart showing a procedure of data processing performed in the SCS data processing part 301 and in the OCS data processing part 302 according to the first embodiment of the present invention;

FIG. 10 is a flowchart showing a procedure of the key operation reproducing process performed by the data reproducing part 306 in the key monitor 117 according to the first embodiment of the present invention;

FIG. 11 shows data flow among the operation panel 210, the key monitor 117, the SCS 122 and applications in the key operation recording process according to the first embodiment of the present invention;

FIG. 12 shows data flow within the key monitor 117 in the key operation recording process according to the first embodiment of the present invention;

FIG. 13 shows a data flow among the operation panel 210, the key monitor 117, the SCS 122 and applications in the key operation reproducing process according to the first embodiment of the present invention;

FIG. 14 shows data flow within the key monitor 117 in the key operation reproducing process according to the first embodiment of the present invention;

FIG. 15 mainly shows the configuration of the key monitor 117 and data flows for key operation recording according to the second embodiment of the present invention;

FIG. 16 is a figure for explaining an initial procedure of the key operation reproducing process in the compound machine according to the third embodiment of the present invention;

FIG. 17 shows the compound machine 100 that is the same as one shown in FIG. 1 according to the fourth embodiment of the present invention, in which FIG. 17 shows parts corresponding to the engine I/F shown in FIG. 17 in detail;

FIG. 18 shows configurations of the OCS drivers 2101 and 2102 according to the fourth embodiment of the present invention.

### DETAILED DESCRIPTION OF THE PREFERRED EMBODIMENTS

In the following, embodiments of a key operation monitoring method, a drawing information obtaining method, a key operation reproducing method for improving efficiency of debugging, and a program for causing a computer to execute the methods, and an image forming apparatus of the present invention will be described with reference to figures.

(First Embodiment)

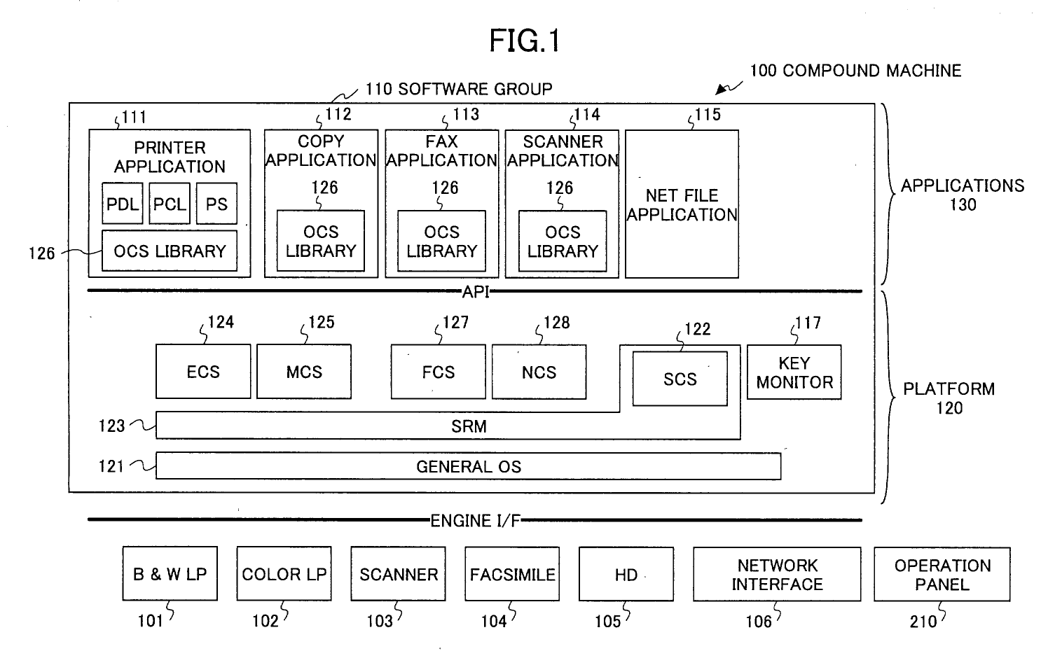

FIG. 1 is a block diagram of an image forming apparatus (to be referred to as a compound machine hereinafter) according to the first embodiment of the present invention. As shown in FIG. 1, the compound machine 100 includes hardware resources and a software group 110. The hardware resources include a black and white line printer (B&W LP) 101, a color line printer 102, a scanner 103, a facsimile 104, a hard disk 105 and a network interface 106. The software group 110 includes a platform 120 and applications 130.

The platform 120 includes control services for interpreting a process request from an application to issuing an acquiring request for the hardware resources, a system resource manager (SRM) 123 for managing one or more hardware resources and arbitrating the acquiring requests from the control service, and a general-purpose OS 121.

The control services include a system control service (SCS) 122 formed by a plurality of service modules, an engine control service (ECS) 124, a memory control service (MCS) 125, a fax control service (FCS) 127, and a network control service (NCS) 128 and a key monitor 117. In addition, the platform 120 has application program interfaces (API) that can receive process requests from the applications 130 by predetermined functions.

The general purpose OS 121 is a general purpose operating system such as UNIX, and can execute each piece of software of the platform 120 and the applications 130 concurrently.

The key monitor 117 receives a key operation by a user from the operation panel 210 as key event information from the SCS 122, and receives, from each application, drawing information to be displayed on the operation panel 210 by each application. In addition, the key monitor 117 adds a time stamp and the like to the received key event information and the drawing information, and stores the information in the hard disk 105 as history data. In addition, the key monitor 117 sends the key event to the SCS 122 on the basis of the history data to reproduce the key operations. The key monitor 117 corresponds to a key monitoring part, a drawing information part and a reproducing part.

Processes of the SRM 123 are for performing control of the system and performing management of resources with the SCS 122. The processes of the SRM 123 perform arbitration and execution control for requests from the upper layer that uses hardware resources including engines such as the scanner part and the printer part, a memory, a HDD file, a host I/Os (Centronics I/F, network I/F IEEE1394 I/F, RS232C I/F and the like).

Specifically, the SRM 123 determines whether the requested hardware resource is available (whether it is not used by another request), and, when the requested hardware resource is available, notifies the upper layer that the requested hardware resource is available. In addition, the SRM 123 performs scheduling for using hardware resources for the requests from the upper layer, and directly performs processes corresponding to the requests (for example, paper transfer and image forming by a printer engine, allocating memory area, file generation and the like).

The processes of the SCS 122 perform application management, control of the operation part, display of system screen, LED display, resource management, and interrupt application control. In addition, the processes of the SCS 122 obtains a key operation from the operation panel 210 as a key event, and sends it to an application and to the key monitor 117. In addition, the SCS 122 includes a mode switching function. The mode switching function is executed by a function call from the key monitor 117. By executing the mode switching function, the SCS process 122 moves to a reproducing mode in which the key event from the operation panel 210 is shut off, and only key event information from the key monitor 117 is received.

Processes of the ECS 124 control hardware resources including the white and black line printer (B&W LP) 101, the color line printer (Color LP) 102, the scanner 104, and the facsimile 104. The process of the MCS 125 obtains and releases an area of the image memory, uses the hard disk apparatus (HDD), and compresses and expands image data.

The processes of the FCS 127 provides APIs for sending and receiving of facsimile from each application layer of the system controller by using PSTN/ISDN network, registering/referring of various kinds of facsimile data managed by BKM (backup SRAM), facsimile reading, facsimile receiving and printing, and mixed sending and receiving.

The NCS 128 is a process for providing services commonly used for applications that need network I/O. The NCS 128 distributes data received from the network by a protocol to a corresponding application, and acts as mediation between the application and the network when sending data to the network.

The application 130 includes a printer application 111 that is an application for a printer having page description language (PDL) and PCL and post script (PS), a copy application 112, a fax application 113 that is an application for facsimile, a scanner application 114 that is an application for an scanner, a network file application 115 and a process check application 116.

Each of the printer application 111, the copy application 112, the fax application 113 and the scanner application 114 includes an OCS library 126 in the inside. That is, each of the applications is an executable file in which the program is linked with the OCS library 126. The OCS liberally 126 registers various functions for controlling the operation panel that is an information delivering means between the operator (user) and the main body. When each application executes a corresponding drawing function registered in the OCS liberally 126, drawing information such as window, button and other character and graphics are displayed on the display part in the operation panel.

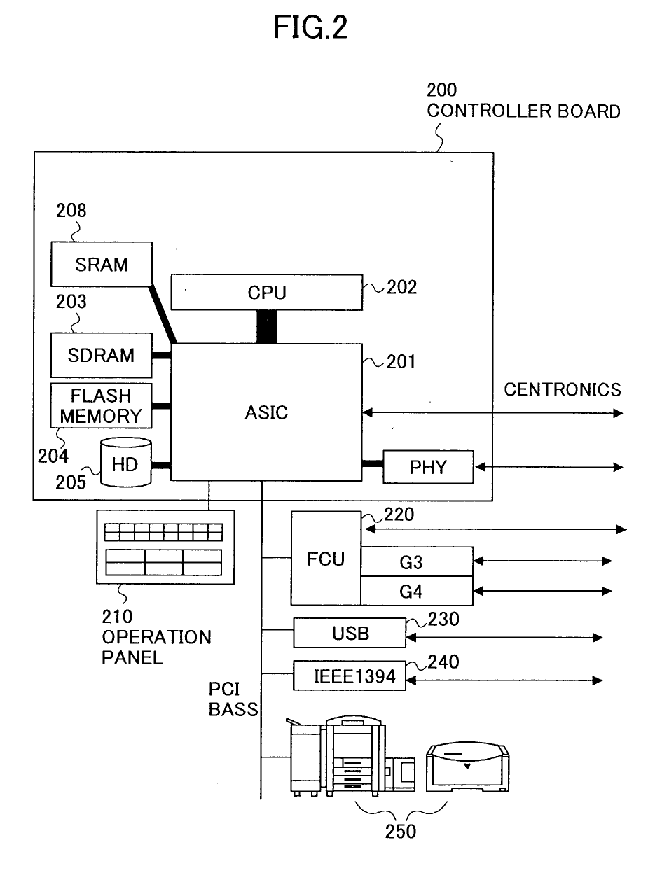

FIG. 2 shows a hardware configuration of the compound machine 100 according to the first embodiment. As shown in FIG. 2, the compound machine 100 includes a controller board 200 in which a CPU 202, a SDRAM 203, a SRAM 208, a flash memory 204 and a HD 205 are connected to an ASIC 201, an operation panel 210, a fax control unit (FCU) 220, an USB 230, an IEEE 1394 240 and a printer 250. The operation panel 210 is directly connected to the ASIC 201. The FCU 220, the USB 230, the IEEE1394 240 and the printer 250 are connected to the ASIC 201 via a PCI bus. The flash memory 204 stores above-mentioned applications, control services forming the platform 120 and applications for the SRM 123.

The operation panel 210 is used for providing an instruction such as for selecting a function to the compound machine 100 by the user. The operation panel 210 includes a display part such as a touch panel. The display part displays, via the OCS liberally 126, selection instructions for selecting functions such as magnification, sort and staple, and, displays drawing data such as buttons of selection instructions such as OK, cancel, and displays drawing data such as window characters, graphics, in which these instructions and drawing data are sent from the printer application 111, the copy application 112, the fax application 113 and the scanner application 114.

When a user pushes (touches) a key such as a button displayed on the display part in the operation panel 210, the key operation by the user is detected as a key event in the SCS 122.

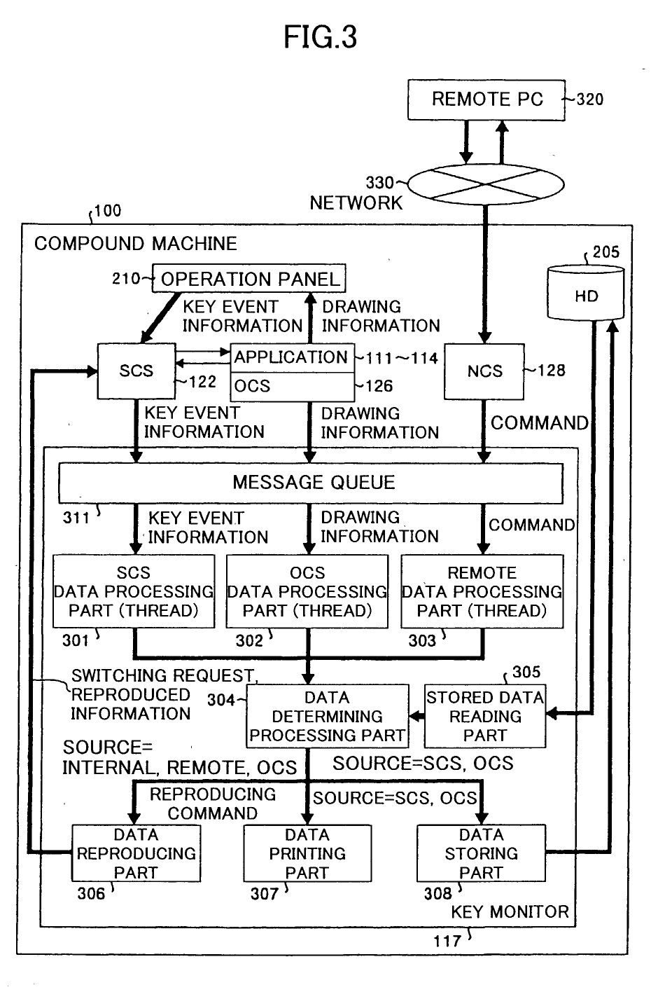

FIG. 3 shows a block diagram of the key monitor 117 according to the first embodiment of the present invention. As shown in FIG. 3, the key monitor 117 includes a message queue 311, an SCS data processing part 301, an OCS data processing part 302, a remote data processing part 303, a data determining processing part 304, a stored data reading part 305, a data reproducing part 306, a data printing part 307, and a data storing part 308. The SCS data processing part 301 corresponds to a key event processing part. The OCS data processing part 302 corresponds to a drawing information processing part. The stored data reading part 305 corresponds to a stored data obtaining part. The data reproducing part 306 corresponds to a reproducing part. The data storing part 308 corresponds to a key event storing part and a drawing information storing part.

The message queue 311 stores messages sent from the SCS process 122, applications 130 (applications 111-114) and the NCS 128. Key event information is sent to the message queue 311 from the SCS process 122, and drawing information is sent to the message queue 311 from the applications 111-114. In addition, the message queue 311 receives and stores a command, via the NCS process 128, sent from a remote PC 320 connected to a network 330 such as a LAN.

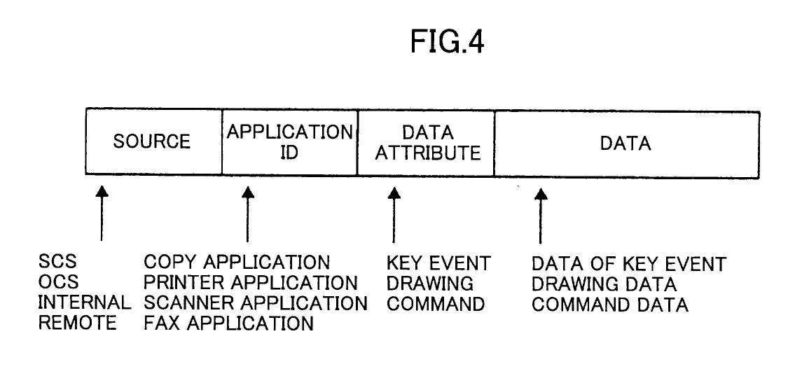

FIG. 4 shows a data structure of the message sent to the message queue 311. As shown in FIG. 4, the message includes a field of a source of the message, a field of an application ID indicating an application that generates the drawing information or uses the key event, a field of a data attribute indicating the kind of the message, and a field of data.

The source field include a code that is “SCS”, “OCS”, “internal”, or “remote”. When the message is a command sent from the remote PC 320, “remote” is set in the source field. The code “internal” indicates that the message is history data stored in the hard disk 105. However, in the key monitor 117 in the first embodiment, the history data is not sent to the message queue 311.

One of codes including “key event”, “drawing”, and “command” is set in the data attribute field at the source of the message. The code “key event” indicates that the message is key event information. The code “drawing” indicates that the message is drawing information. The code “command” indicates that the message is a command. When the data attribute is the drawing information, there are two cases in which the source is “OCS” or the source is “internal”. When the source is “internal”, the message is drawing information in the history data stored in the hard disk 105.

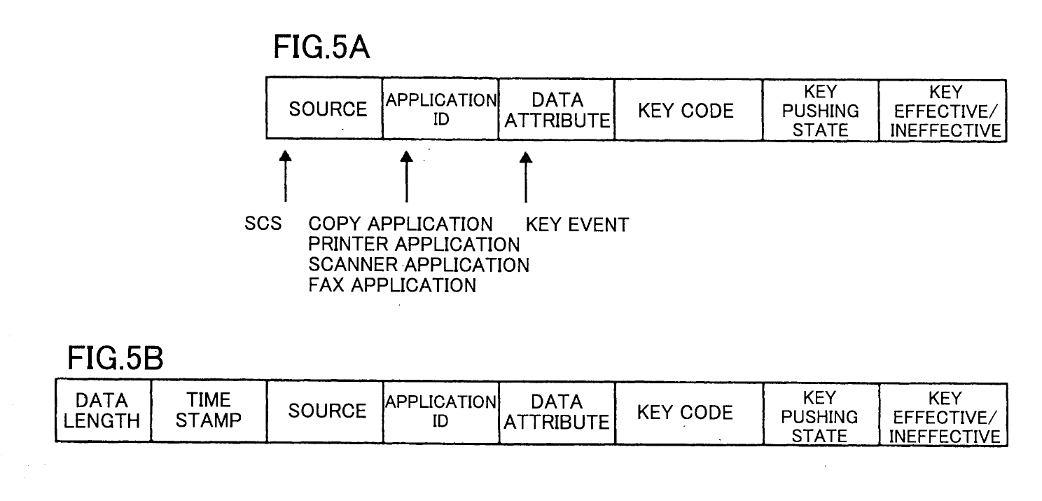

The kind of data in the data field varies according to the data attribute. FIG. 5A shows data structure of key event information stored in the message queue 311, that is, before the key event information is processed by the SCS data processing part 301. As shown in FIG. 5A, in the key event information, “SCS” is set in the source field and “key event” is set in the data attribute field at the source (SCS) of the message. In a key code field, a key code is set, wherein the key code is an identification code of a key that is operated on the operation panel 210. In a key push state field, a code indicating whether the key is pushed is set. In a key effective/ineffective field, a code indicating whether the key corresponding to the key code is effective or ineffective is set.

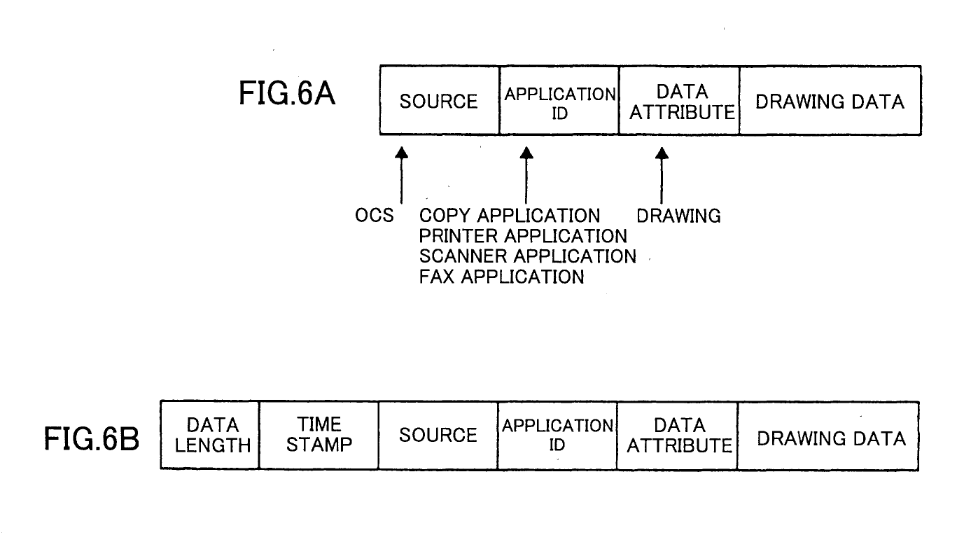

FIG. 6A shows a data structure of the drawing information stored in the message queue 311, that is, the drawing information stored in the message queue 311 is one before it is processed by the OCS data processing part 302. As shown in FIG. 6A, as for the drawing information, “OCS” is set in the source field and “drawing” is set in the data attribute field at the OCS library 126 of the application (111-114). In the drawing data field, drawing data is set at the OCS library 126, wherein the drawing data is a window ID, an item ID indicating an attribute such as shading such as button, character information, graphics information, or the like.

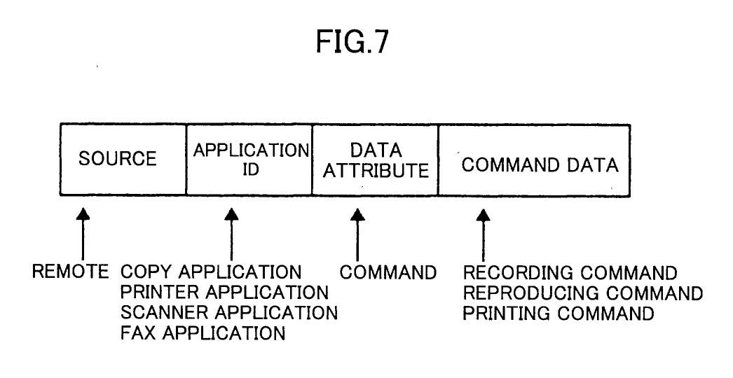

FIG. 7 shows a data structure of a command stored in the message queue 311. As shown in FIG. 7, “remote” is set in the source field and “command” is set in the data attribute field in the remote PC 320. In the command data field, identification data for each of commands such as a recording command and a reproducing command is set in the remote PC 320 that is the source.

The SCS data processing part 301 is a thread that is generated and operates in the process of the key monitor 117. The SCS data processing part 301 obtains key event information from the message queue 311, performs data analysis and adds a time stamp. The OCS data processing part 302 is a thread that is generated and operates in the process in the key monitor 117. The OCS data processing part 302 obtains drawing information from the message queue 311, performs data analysis and adds a time stamp.

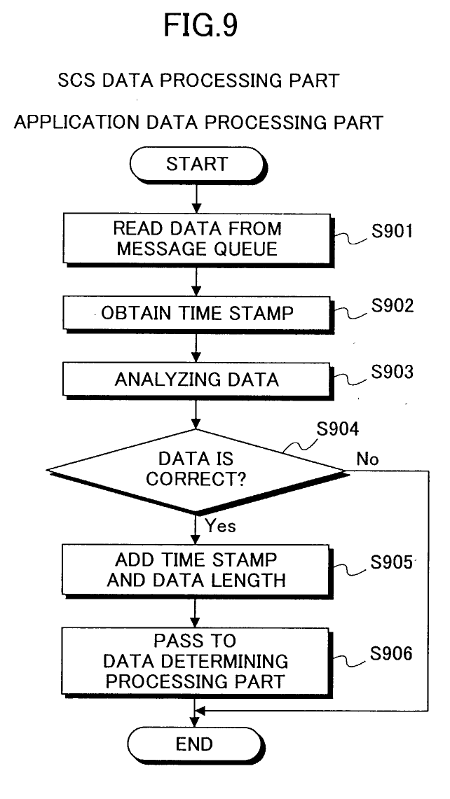

FIG. 9 is a flowchart showing a procedure of data processing performed in the SCS data processing part 301 and in the OCS data processing part 302. In each of the data processing parts 301 and 302, the message queue 311 is searched for data (message) to be processed at predetermined time interval, and if there is data to be processed, the data is read in step S901.

More specifically, in the SCS data processing part 301, data in which the source is “SCS” and the data attribute is “key event” is searched for from the message queue 311. If the data is detected, the SCS data processing part 301 determines that the data is key event information sent from the SCS 122 and reads the data. In the OCS data processing part 302, data in which the source is “OCS” and the data attribute is “drawing” is searched for from the message queue 311. If the data is detected, the OCS data processing part 302 determines that the data is drawing information sent by an applications (111-114) by using the OCS library 126 and reads the data.

Next, the current time is obtained as a time stamp from a timer provided in the compound machine 100 in step S902. Then, data analysis is performed for determining whether the data read in the step S901 complies with the data structure to be processed in the data processing part 301 or 302 in step S903.

More specifically, the SCS data processing part 301 determines whether the data has the data structure of the key event information shown in FIG. 5A, and the OCS data processing part 302 determines whether the data has the data structure of the drawing information shown in FIG. 6A.

Then, by performing the data analysis, the data processing part determines whether the read data is correct in step S904. If the data is not correct, the process ends without performing remaining processes.

When the data is correct, the current time obtained in step S902 is added to the data as the time stamp, in addition, data length is added to the data in step S905. After that, the data is passed to the data determining processing part 304 in step S906. An identification such as data reproducing, data printing and data storing may be further added to the key event information for smoothing the determining process in the data determining processing part 304.

FIG. 5B shows a data structure of the key event information after processed by the SCS data processing part 301. FIG. 6B shows a data structure of the drawing information after processed by the OCS data processing part 302. As shown in FIG. 5B and FIG. 6B, in each head of the key event information and drawing information, data length and time stamp are added by the processes performed by the SCS data processing part301 and the OCS data processing part 302.

The remote data processing part 303 performs data processing for a command sent from the remote PC 320 via the network, and is a thread that is generated and operates in the process in the key monitor 117. However, the time stamp and the data length are not added to the command. The remote data processing part 303 searches the message queue 311 for data including “remote” in the source field, and determines that the data is a command sent from the remote PC 320 and read the data. Then, the remote data processing part 303 performs data analysis to determine whether the data structure of the read data complies with the data structure of the command shown in FIG. 7. When the data is correct, the data is passed to the data determining processing part 304.

The data determining processing part 304 checks the source field, the data attribute field or the data field in each data received from the data processing parts 301, 302 and 303, and passes the data to the data reproducing part 306, the data printing part 307 or the data storing part 308. More specifically, when the source field indicates “internal” or “OCS”, or when the source field is “remote” and the data attribute is “command” and the data is the reproducing command, the data is passed to the data reproducing part 306. Therefore, the data reproducing part 306 receives history data, the drawing information shown in FIG. 6B and the reproducing command of the structure shown in FIG. 7.

When the source is “SCS” or “OCS”, the data determining processing part 304 sends the data to the data printing part 307 and the data storing part 308. Therefore, the data printing part 307 and the data storing part 308 receive the key event information and the drawing information shown in FIG. 5B and FIG. 6B to which the time stamp is added.

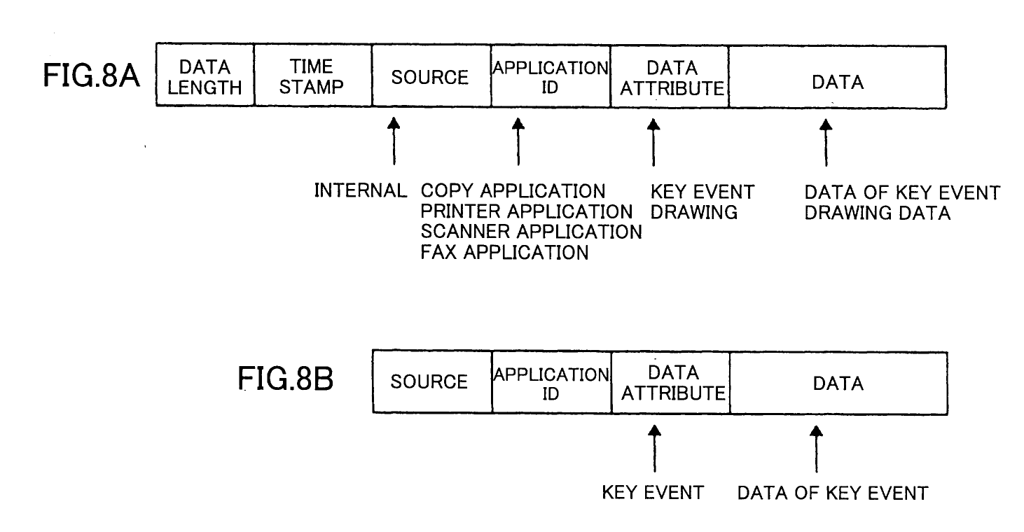

The data storing part 308 stores the key event information and the drawing information to which the time stamp is added in the hard disk (HD) 105 as history data. At this time, the source filed of each data is set to be “internal”. FIG. 8A shows a data structure of each record of the history data (internal data). As shown in FIG. 8A, “internal” is set in the source field, and the data field is the same as that in the key event information and the drawing information. The history data includes a plurality of records each of which is the data shown in FIG. 8A, wherein the data is collected to form the records over time.

The data printing part 307 is used for printing the key event information and the drawing information by the printers 101 and 102 when the printing command is sent from the remote PC 320. The stored data reading part 305 reads history data shown in FIG. 8A from the hard disk 105, and passes the data to the data determining processing part 304 when the mode is set to be an after-mentioned reproducing mode. In the reproducing mode, the data reproducing part 306 performs a mode switching function call to the SCS process 122 for switching the mode to the reproducing mode, generates reproduced information from the history data and sends the reproduced data to the SCS process 122 so as to reproduce key operation on the basis of the history data.

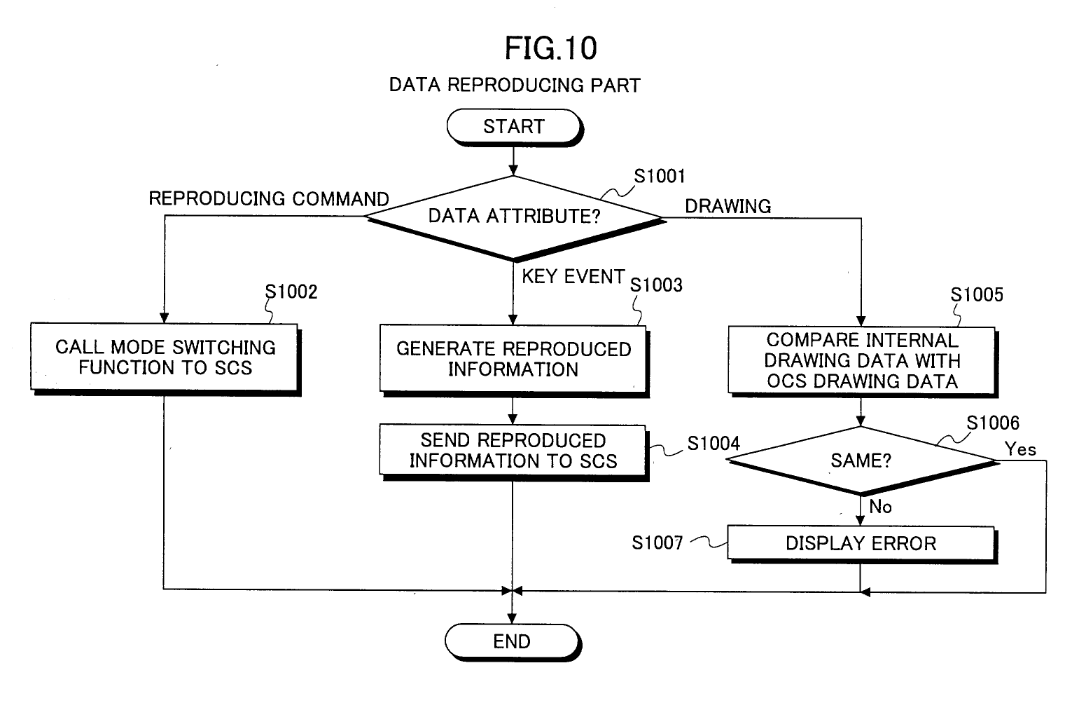

FIG. 10 is a flowchart showing a procedure of the key operation reproducing process performed by the data reproducing part 306 in the key monitor 117 according to the first embodiment. As shown in FIG. 10, first, the data reproducing part 306 checks the data attribute of data that is received from the data determining processing part 304 in step S1001. When the data attribute is “command” and the data field is, “reproducing command”, the data reproducing part 306 calls the mode switching function from the SCS process 122 in step S1002. As a result, the mode switching function is executed in the SCS process 122, so that the mode is changed to the reproducing mode in which key events from the operation panel 210 are shut off and only reproduced information (key event information) is received from the key monitor 117.

When the data attribute is “key event”, the data received from the data determining processing part 304 is the history data of key event information. Therefore, the data reproducing part generates reproduced information in which the data length and the time stamp are deleted from the history data in step S1003. FIG. 8B shows a data structure of the generated reproduced information. The difference between the reproduced information and the key event information shown in FIG. 5A is that the source of the reproduced information is “internal”. Then, the reproduced information is sent to the SCS process 122 in step S1004. This process is performed for each record of the key event information included in the history data. Each piece of the reproduced information is sent at an interval which is a time difference between the deleted time stamp and the time stamp of a next record. Therefore, key operations are reproduced at intervals same as those for actual key operations performed by the user on the operation panel 210, so that debugging that conforms to the actual operation can be performed.

When the data attribute is “drawing”, the data received from the data determining processing part 304 are drawing information in the history data and drawing information received from the applications 111-114 via the OCS library 126, that is, drawing information generated by reproducing the key operation and executing the applications 111-114. The data reproducing part compares both pieces of drawing information in step S1005, and determines whether they are the same in step S1006.

As a result of the comparison, when they are the same, it is determined that drawing information displayed on the operation panel 210 by reproducing the key operation is normal. On the other hand, when they are not the same, it is determined that drawing information displayed on the operation panel 210 by reproducing the key operation is abnormal, and an error is displayed on the operation panel 210 or on the remote PC 320 in step S1007.

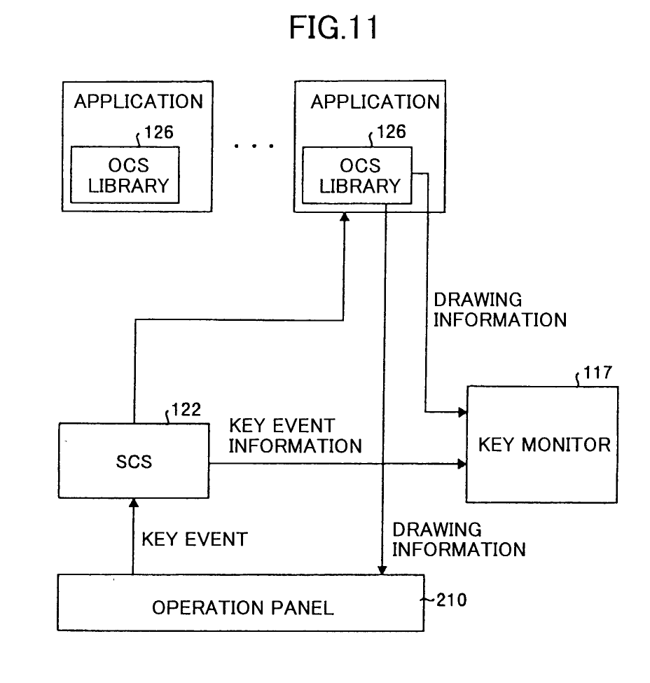

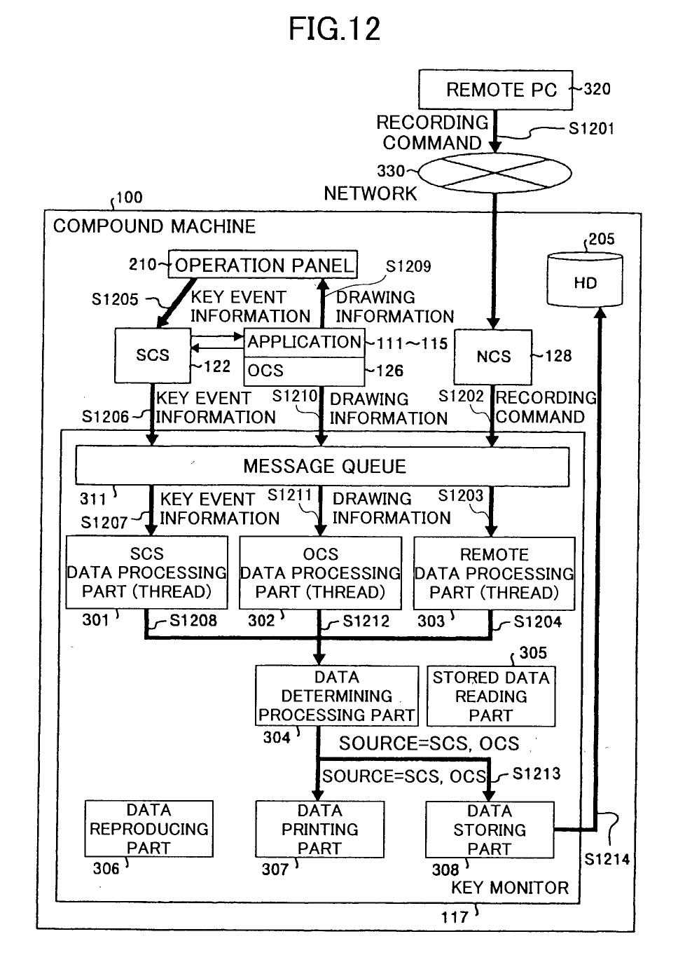

Next, a key operation recording process by the compound machine 100 including the key monitor 117 will be described. FIG. 11 shows data flow among the operation panel 210, the key monitor 117, the SCS 122 and applications in the key operation recording process. FIG. 12 shows data flow within the key monitor 117 in the key operation recording process.

When a recording command is sent from the remote PC 320 in step S1201, the NCS process in the compound machine 100 receives the recording command via the network, and records the command in the message queue 311 in the key monitor 117 in step S1202. The remote data processing part 303 in the key monitor 117 obtains the recording command from the message queue 311 in step S1203, and performs data analysis. Then, the key operation recording process starts. The recording command is output to the data determining processing part 304 in step S1204.

When the user performs a key operation on the operation panel 210, key event information corresponding to the operated key is notified of to the SCS process 122 in step S1205. The SCS process 122 sends the notified key event information to an application (111-114) specified by the application ID, and registers the key event information to the message queue 311 of the key monitor 117 by interprocess communication such as message sending or function call in step S1206.

The SCS data processing part 301 in the key monitor 117 obtains the key event information from the message queue 311 in step S1207, performs before-mentioned data analysis and adding of the time stamp, and passes the key event information to the data determining processing part 304 in step S1208.

The data determining processing part 304 determines the source of the key event information, and outputs the key event information to the data storing part 308. Then, the data storing part 308 stores the history data in the hard disk 105 in which the source is set to be “internal”.

The above-mentioned processes for obtaining the key event information and storing as the history data are performed every time when the key operation is performed on the operation panel 210, so that a plurality of pieces of key event information are recorded as the history data one after another.

Each of the applications 111-114 that receives key event information from the SCS process 122 performs processes specific to the application. At this time, there is a case where drawing information is output on the operation panel 210 in step S1209. In this case, the application 111-114 executes a drawing information sending function in the OCS library 126. The drawing information sending function is a function operating with a function in the OCS library 126 for the application 111-114 to output drawing information to the operation panel 210. The drawing information sending function is for sending the same drawing information as the drawing information that is output to the operation panel 210 to the message queue 311 of the key monitor 117. Thus, the drawing information output to the operation panel 210 is also sent to the message queue 311 of the key monitor 117 in step S1210.

The OCS data processing part 302 in the key monitor 117 obtains the drawing information from the message queue 311 in step S1211, performs data analysis, and adds a time stamp. Then, the drawing information is passed to the data determining processing part 304 in step S1212. The data determining processing part 304 determines the source of the drawing information and outputs the drawing information to the data storing part 308 in step S1213. Then, the data storing part 308 stores history data in which the source is set to be “internal” into the hard disk 105 in step S1214.

The above-mentioned processes for obtaining the drawing information and storing as the history data are performed every time when the drawing information is sent to the operation panel 210 from the applications 111-114, so that a plurality of pieces of drawing information are recorded as the history data one after another.

In the key monitor 117 according to the first embodiment, the SCS data processing part 301 and the OCS data processing part 302 are operating as threads. Thus, data processing by the SCS data processing part 301 and data processing by the OCS data processing part 302 are performed concurrently. Therefore, even when key operation and output of drawing information to the operation panel 210 are performed in a short interval or at the same time, both of the data processing can be performed concurrently. In addition, the time stamp does not differ from actual time. According to the above-mentioned key operation recording process, the history data including the key event information and the drawing information is stored in the hard disk 105.

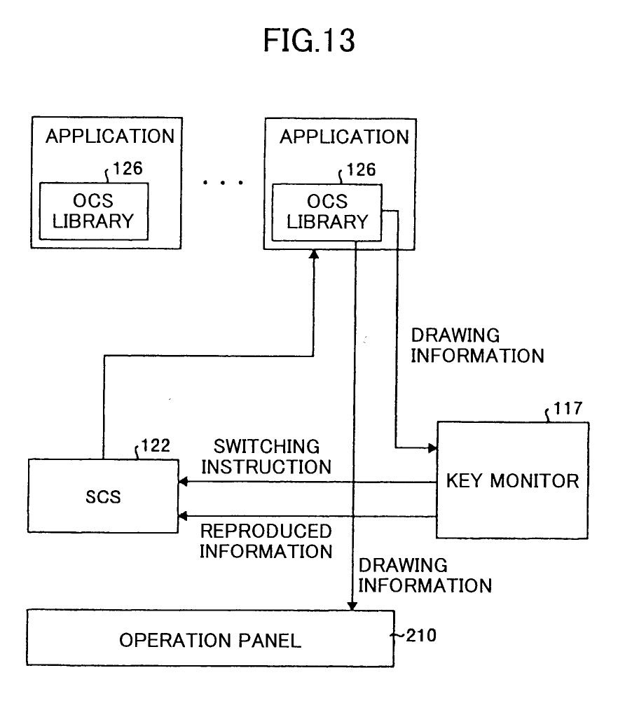

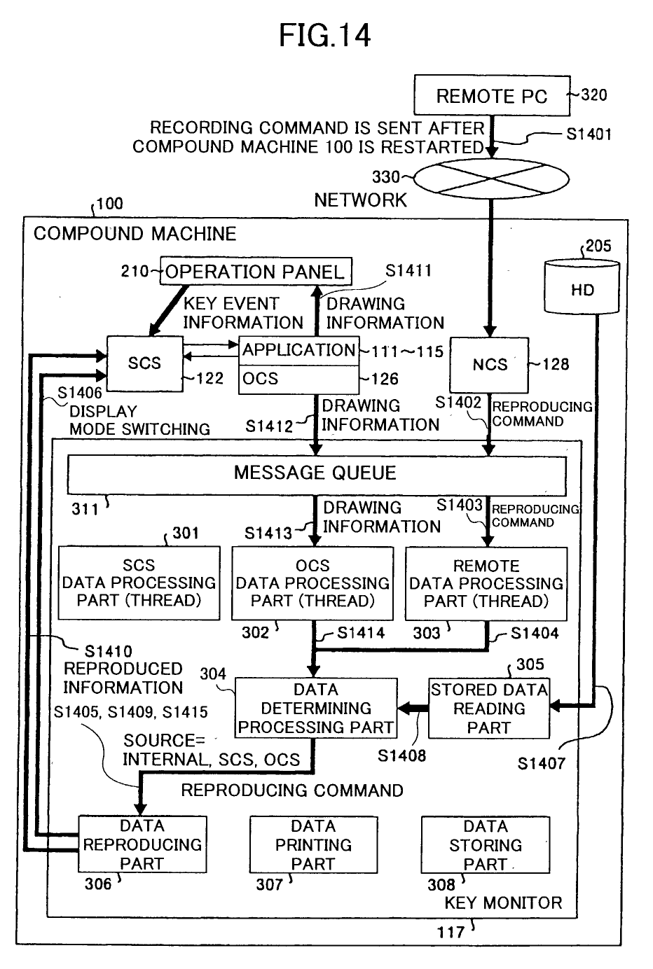

Next, a key operation reproducing process in the compound machine 100 including the key monitor 117 according to the first embodiment will be described. FIG. 13 shows a data flow among the operation panel 210, the key monitor 117, the SCS 122 and applications in the key operation reproducing process. FIG. 14 shows data flow within the key monitor 117 in the key operation reproducing process.

When performing the key operation reproducing process, the compound machine 100 is restarted. When all processes and the key monitor 117 restart, a reproducing command is sent from the remote PC 320 in step S1401. The NCS process 128 in the compound machine 100 receives the reproducing command via the network, and registers the reproducing command in the message queue 311 in the key monitor 117 in step S1402.

The remote data processing part 303 in the key monitor 117 obtains the reproducing command from the message queue 311 in step S1403, performs data analysis, and outputs to the data determining processing part 304 in step S1404. The data determining processing part 304 recognizes that the source of the input data is “remote”, the data attribute is “command”, and command data is the reproducing command, and passes the reproducing command to the data reproducing part 306 in step S1405.

Since the input data is the reproducing command, the data reproducing part 306 calls a mode switching function to the SCS process 122, and requests switching to the reproducing mode in step S1406. The SCS process 122 executes the mode switching function, so that the mode is changed to the reproducing mode. Accordingly, as shown in FIG. 13, the SCS process 122 becomes in the reproducing mode in which the SCS process 122 receives only the reproduced information from the key monitor 117, and key operations from the operation panel 210 are shut off.

Next, the storing data reading part 305 reads history data stored in the hard disk 105 in step S1407, and passes the history data to the data determining processing part 304 in step S1408. Since the source of the history data is “internal”, the data determining processing part 304 passes the history data to the data reproducing part 306 in step S1409. The data reproducing part 306 determines the data attribute for each record of the input history data. When the data attribute is “key event”, the data length and the time stamp are deleted to generate reproduced information. Then, the reproduced information is sent to the SCS process 122 by massage sending that is interprocess communication in step S1410.

The SCS process 122 sends the key code of the received reproduced information to the applications 111-114, so that key operation reproducing process on the basis of the history data is performed.

More particularly, the data reproducing part 306 generates the reproduced information for every record of which the data attribute is “key event”, and sends the reproduced information to the SCS process 122. Each pieces of the reproduced information is sent at a time interval between a time indicated by the time stamp that is deleted while generating a previous reproduced information and a time indicated by the time stamp deleted from reproduced information to be sent at this time. That is, each piece of the reproduced information is sent at an interval same as that for the actual key operation, so that the key operation is reproduced.

The data reproducing part 306 generates the reproduced information when the data attribute is “key event”. When the data attribute is “drawing” and the source is “internal”, the reproducing process is not performed and the data is held.

The SCS process 122 sends a key event in the reproduced information received from the data reproducing part 306 to the application 111-114 so as to reproduce the key operation. When the application 111-114 sends drawing information such as a button displayed on the operation panel 210 in step S1411, the drawing information is received by the key monitor 117 in steps S1412, S1413, and S1414 in the same way as the key operation recording process described with reference to FIG. 12.

The drawing information received from the application 111-114 is sent to the data reproducing part 306 by the data determining processing part 304 in step S1415, since the source is “OCS”. Since the source is “OCS” and the data attribute is “drawing” in the drawing information, the data reproducing part 306 determines whether this drawing information and the drawing information in the history data are the same by comparing them. When they are the same, it is determined that the drawing information displayed on the operation panel 210 from the application by the key operation is normal. However, when they are not the same, it is determined that the application 111-114 is abnormal, so that the data reproducing part 306 notifies the operation panel 210 or the remote PC 320 of an error. As mentioned above, by reproducing the key operation, it can be determined whether drawing information displayed on the operation panel 210 is normal.

As mentioned above, according to the compound machine 100 of the first embodiment, the key monitor 117 obtains key event information by interprocess communication from the operation panel 210 via the SCS process 122, and obtains drawing information from the applications 111-114 to the operation panel 210 by interprocess communication. In addition, the key monitor 117 stores the key event information and the drawing information as the history data in the hard disk 105 by adding the time stamp. Therefore, a series of key operations can be easily reproduced at the interval of the time stamp. Thus, useful debugging information can be obtained.

In addition, according to the compound machine 100 of the first embodiment, the key operation is reproduced by generating the reproduced information from the history data and sending the reproduced information to the SCS process 122. Therefore, since a series of key operations can be automatically reproduced repeatedly, efficiency of debugging and evaluation can be improved.

In the above-mentioned compound machine according to the first embodiment, when the key operation reproducing process is started, the reproducing command is sent to the compound machine 100 from the remote PC 320, and the mode switching function is called when the compound machine 100 receives the reproducing command 100. However, other method can be used for calling the mode switching function in which the compound machine 100 generates the reproducing command to call the mode switching function.

For example, the compound machine 100 can be configured such that, when a predetermined combination of keys (for example, “[clear]”+“1”+“2”+“3”+“[clear]”) is input from the operation panel, the mode switching function is called. In addition, the compound machine 100 can be configured such that, a special key is provided, and, the mode switching function is called when the special key is pushed.

(Second Embodiment)

The compound machine 100 of the first embodiment stores the history data of the key event information and the drawing information in the hard disk 105. The compound machine 100 of the second embodiment sends the history data to the remote PC 320. Software and hardware configurations of the compound machine according to the first embodiment are the same as those of the compound machine 100 of the first embodiment shown in FIGS. 1 and 2.

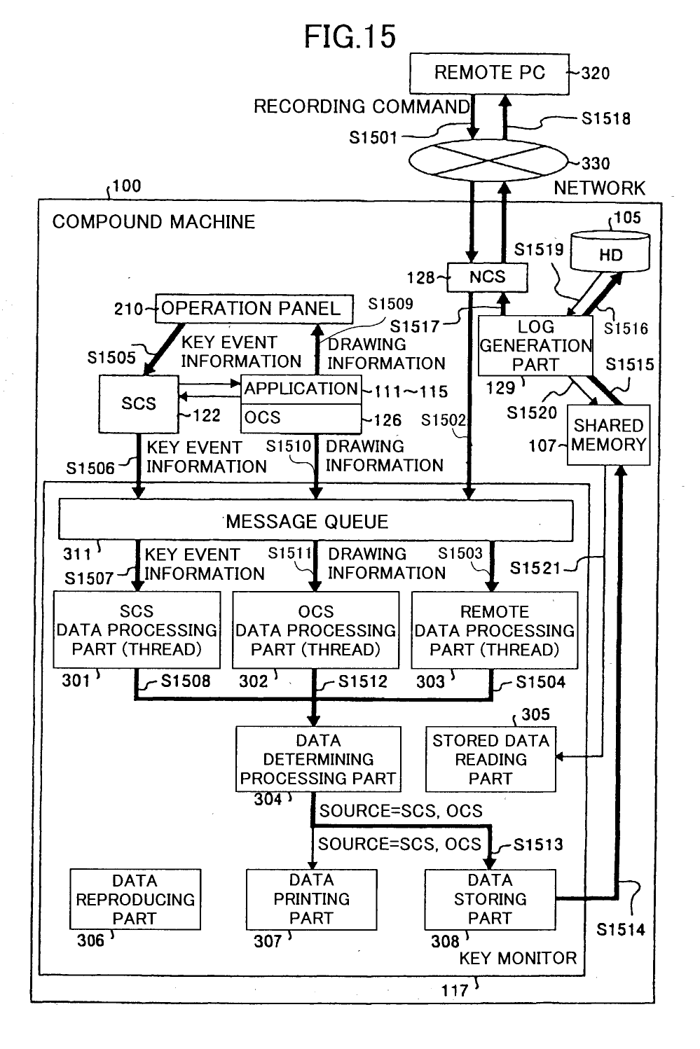

FIG. 15 mainly shows the configuration of the key monitor 117 and data flows for key operation recording. As shown in FIG. 15, the compound machine 100 of the second embodiment includes a shared memory 107 and a log generation part 129 that are not included in the first embodiment.

The log generation part 129 is a process operating in the compound machine 100. The log generation part 129 obtains key event information and drawing information from the shared memory and generates history data. Then, the log generation part 129 sends the history data to the remote PC 320 connected to a network via the NCS process 128, and stores the history data in the hard disk 105. In addition, the log generation part 129 stores the history data stored in the hard disk 105 in the shared memory 107. The log generation part 129 corresponds to a key event storing part and a drawing information storing part. In addition, the log generation part 129 can be configured so as to receive history data from the remote PC 320 and store it in a shared memory 107.

The shared memory 107 is kept in the SDRAM 203, and has an area that can be commonly accessed by the processes of the key monitor 117 and a process of the log generation part 129.

Next, a key operation recording process in the compound machine 100 according to the second embodiment will be described. Processes from the process of sending the recording command from the remote PC 320 to the process of passing the key event information and the drawing information (steps S1501-S1513) to the data storing part 308 are the same as those shown in FIG. 12 which was described in the first embodiment.

The data storing part 308 sends key event information (FIG. 5B) and the drawing information (FIG. 6B), in which the time stamp is added to them, to the log generation part 129 by interprocess communication by using the shared memory 107. That is, the data storing part 308 writes the key event information (FIG. 5B) and the drawing information (FIG. 6B) to which the time stamp is added in the shared memory 107 in step S1514. Then, the process of the log generation part 129 accesses the shared memory 107 and obtains the key event information and the drawing information from the shared memory 107 in step S1515, so that the key event information and the drawing information can be passed by interprocess communication of the shared memory 107 and the log generation part 129.

The log generation part 129 generates history data including a plurality of pieces of key event information and a plurality of pieces of drawing information read from the shared memory 107. Then, the history data is stored in the hard disk 105 in step S1516. The history data is sent to the remote PC 320 over a network via the NCS process 128 by specifying the network address of the remote PC 320 in steps S1517 and S1518.

In the key operation reproducing process, when the key monitor 117 reads the history data, the log generation part 129 reads the history data from the hard disk 105 in step S1519 and writes the history data in the shred memory 107 in step S1520. Then, the stored data reading part 305 in the key monitor 117 accesses the shred memory 107, and reads the history data stored in the shared memory 107 in step S1521. According to the process of the log generation part 129 and interprocess communication of the key monitor 117, the history data can be obtained. Procedures hereinafter in the key operation reproducing process are the same as those shown in FIG. 14 described in the first embodiment.

As mentioned above, according to the compound machine 100 of the second embodiment, the history data is sent to the remote PC 320 connected to the network. Thus, the remote PC 320 can have the history data of the key event information and the drawing information to be used by the user for debugging. Therefor, the remote PC 320 that can receive the history data is convenient for the user to perform debugging at a location remote from the compound machine 100.

(Third Embodiment)

As for the compound machine 100 according to the first and second embodiments, it is necessary to restart the compound machine 100 for changing to the reproducing mode before performing the key operation reproducing process. However, according to the third embodiment, the compound machine is automatically changed to the reproducing mode to perform the key operation reproducing process.

The configuration of the compound machine 100 according to the third embodiment is the same as that in the first embodiment shown in FIGS. 1 and 2. However, as for the compound machine of the third embodiment, the SCS 1622 implements a launch request function for launching the key monitor 117 and a stop function for stopping the process of the key monitor 117.

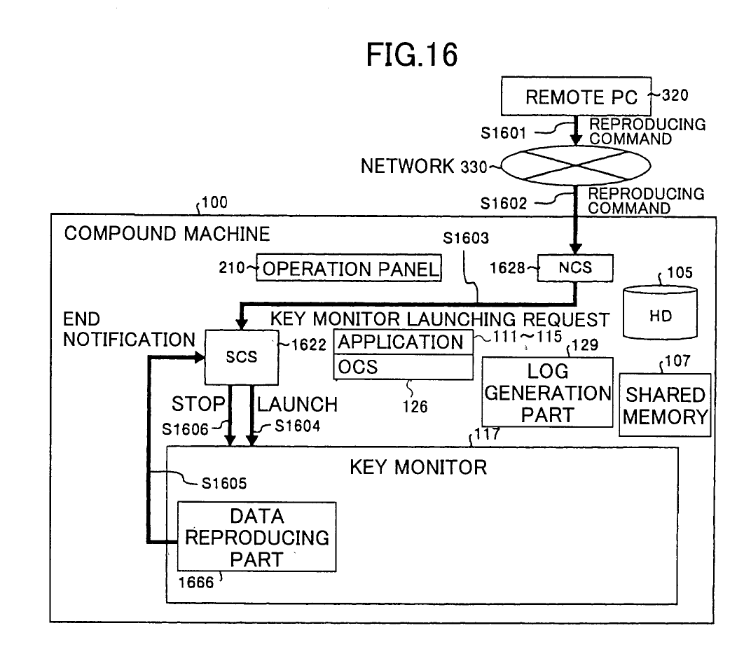

FIG. 16 is a figure for explaining an initial procedure of the key operation reproducing process in the compound machine according to the third embodiment. When the key operation reproducing process is performed by the key monitor 117, first, the remote PC 320 sends a reproducing command in step S1601. At this time, it is not necessary to restart the compound machine 100.

When the NCS process 1628 in the compound machine 100 receives the restarting command via the network in step S1602, the NCS process 1628 calls a key monitor launch request function in the SCS process 1622 in step S1603. The SCS process 1622 executes the key monitor launch request function, so that the process of the key monitor 117 is generated in the compound machine 100 and the process is launched in step S1604.

When the key operation reproducing process ends, the data reproducing part 1666 in the key monitor 117 sends an end notification event message to the SCS process 1622 in step S1605. When receiving the end notification event message, the SCS process 1622 executes the stop function, so that the process of the key monitor 117 disappears in step S1606.

As mentioned above, according to the compound machine 100 of the third embodiment, the SCS 1622 includes a launch function for launching the key monitor 117, it is not necessary to restart the compound machine 100 by executing the launch function when performing the key operation reproducing process, so that usability for debugging improves.

In addition, according to the compound machine of the third embodiment, the key monitor 117 sends a stop request to the SCS process 1622 when the reproducing process of the key operation ends, so that the SCS process 1622 stops the process of the key monitor 117. Thus, the process of the key monitor 117 can be automatically stopped when the key operation reproducing process ends. Therefore, usability of debugging improves.

(Fourth Embodiment)

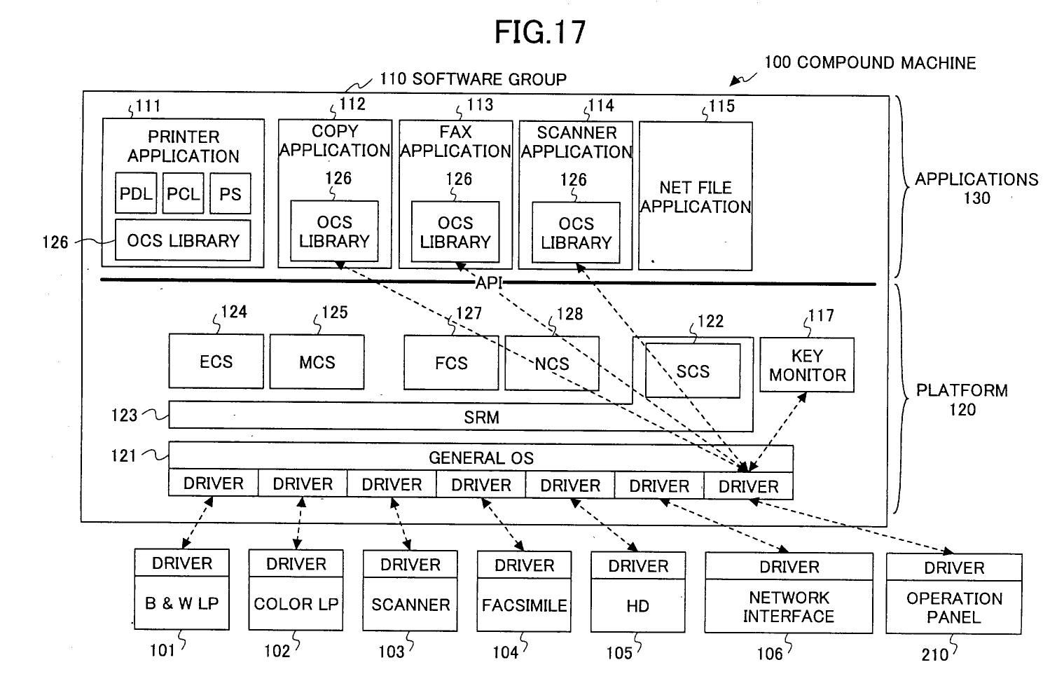

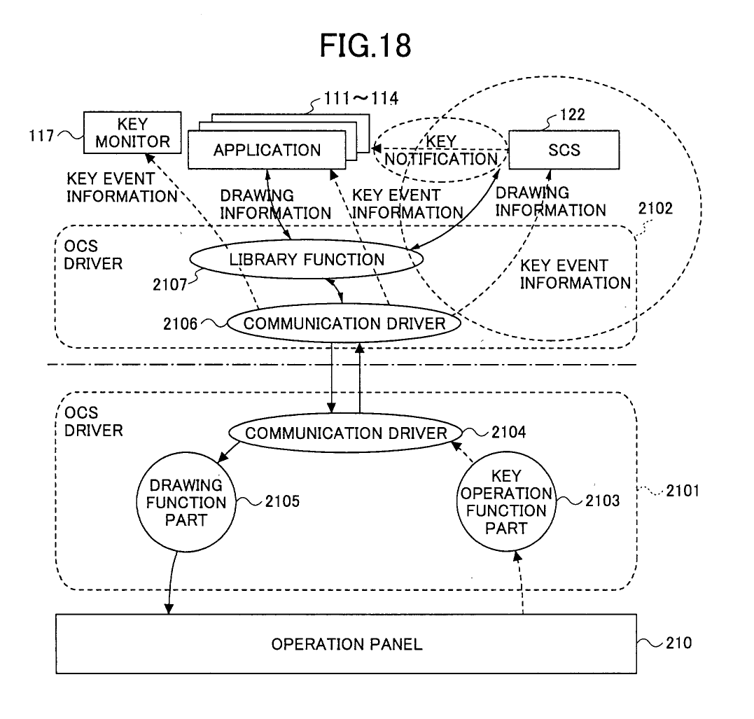

According to the compound machine 100 of the first to third embodiments, the key event information input from the operation panel 210 is sent to the application and to the key monitor 117 via the SCS 122. However, the compound machine 100 can be configured such that a driver for the operation panel 210 sends the key event information directly to the application and to the key monitor 117. In the following, this configuration will be described with reference to FIGS. 17 and 18.

FIG. 17 shows the compound machine 100 that is the same as one shown in FIG. 1, in which FIG. 17 shows parts corresponding to the engine I/F shown in FIG. 17 in detail.

As shown in FIG. 17, drivers in the hardware side and drivers in the OS side are provided corresponding to each hardware part. These drivers forms the engine I/F. In the fourth embodiment, OCS driver in the OS side receives the key event information from the OCS driver 2101 in the hardware side, and the OCS driver 2102 in the OS side sends the key event information to the application and to the key monitor 117 without using the SCS 122.

FIG. 18 shows configurations of the OCS drivers 2101 and 2102. As shown in FIG. 18, in the OCS driver in the hardware side, a key operation function part 2103 detects an key operation input from the operation panel 210, and sends it to a communication driver 2104 as key event information. A drawing function part 2105 receives drawing information from the communication driver 2104, and displays drawing data on the operation panel 210. The communication driver 2104 sends the key event information to a communication driver 2106 in the OCS driver 2102 in the OS side.

In the OCS driver 2102 in the OS side, the communication driver 2106 sends the key event information to each application and to the key monitor 117. In addition, drawing information from the application is sent to the OCS driver 2101 from the communication driver 2106 by using library functions 2107.

Functions that are shown in a dotted line circle in FIG. 18 is used in the first to third embodiments. In the first to third embodiments, the key event information is sent to the SCS 122, and the SCS 122 sends the key event information to the application and to the key monitor 117. For delivering the key event information, the circled part is not used in the fourth embodiment.

As mentioned above, according to the fourth embodiment, the key event information can be sent to the application and to the key monitor 117 without using the SCS 122. In the fourth embodiment, configurations other than the above-mentioned configuration can be the same as configurations of the first to third embodiments.

Although time intervals of key operations are calculated from time stamps added to the key event information and drawing information according to the compound machine 100 of the first to third embodiments, the compound machine 100 can be configured such that the intervals can be calculated beforehand from time stamps and included in the history data while the history data is generated.

In the compound machine 100 according to the first to third embodiments, the key monitor 117 is provided in the control service layer, so that the key monitor 117 can use an application program interface for sending and receiving data to/from the application. However, the key monitor 117 can be provided in the application layer as a key monitor application.

As mentioned above, according to the present invention, the key operation can be obtained by receiving key event information sent by a communication driver in the operation panel. The key event information can be used for debugging. Thus, key operations at a time when a failure arises can be easily reproduced for example, so that debugging can be performed efficiently.

In addition, according to the present invention, key operation monitoring method is provided, in which the image forming apparatus may includes: hardware resources used for image forming processes; an application for performing a process specific for a user service; and a system control service for controlling the operation panel, the system control service being provided between the application and the hardware resources; and the key monitoring step for obtaining a key operation comprises the steps of:

obtaining the key operation as the key event information by the system control service; and

receiving the key event information from the system control service by using interprocess communication.

According to this method, the key event information can be easily obtained in the image forming apparatus in which a plurality of pieces of software operate by using interprocess communication, so that the key event information can be used for debugging. Thus, key operations at a time when a failure arises can be easily reproduced, so that debugging can be performed efficiently.

The key operation monitoring method may further comprises the key event storing step of storing a plurality of pieces of key event information in a storage as key history data.

According to the above-mentioned method, time-series key event information by a series of key operations is stored as history data. Accordingly, key operations at a time when a failure arises can be easily reproduced, so that debugging can be performed efficiently.

The key operation monitoring method may further includes the step of adding time information to the key event information; and

the key event storing step may includes the step of storing the key event information to which the time information is added in the storage as the key history data.

According to the above-mentioned method, each timing of key operations can be recognized according to the time information. Thus, the key operations can be reproduced at the same intervals as actual key operations, so that debugging can be performed more efficiently.

The key operation monitoring method may further includes the step of sending the key history data to a terminal that is connected to a network.

According to the above-mentioned method, the history data can be directly stored in a remote terminal used by a user for debugging. Thus, usability for performing debugging at a place far from the image forming apparatus can be improved.

A drawing information obtaining method can be also provided according to the present invention, in which the drawing information obtaining method is used for obtaining drawing information output to an operation panel in an image forming apparatus, the image forming apparatus comprising an application for providing a user service and the operation panel, the drawing information obtaining method includes: the drawing information obtaining step of receiving the drawing information from the application by using interprocess communication.

According to the above-mentioned method, information that is displayed on the operation panel (drawing information) can be obtained easily. Therefore, drawing information displayed on the operation panel at a time of failure can be easily reproduced, so that debugging for the image forming apparatus can be performed efficiently.

The drawing information obtaining step may includes the step of:

receiving a call for a drawing information sending function from the application, the drawing information sending function corresponding to a function for managing the operation panel.

By using simple interprocess communication such as the function call, drawing information useful for debugging can be easily obtained

In addition, since the drawing information can be received by using the drawing information sending function corresponding to a function for managing the operation panel, it is not necessary to be conscious that drawing information is notified of to a drawing information obtaining module in the stage of application development. Therefore, an application can be developed efficiently.

The drawing information obtaining method may further includes the drawing information storing step of storing a plurality of pieces of drawing information in a storage as drawing history data.

Therefore, time-series drawing information is stored as history data. Accordingly, a series of pieces of drawing information at a time when a failure arises can be easily reproduced, so that debugging can be performed efficiently.

The drawing information obtaining method may includes the step of adding time information to the drawing information that is received; and

the drawing information storing step may includes the step of storing the drawing information to which the time information is added in the storage as the drawing history data.

According to this method, each timing at which each piece of drawing information is displayed on the operation panel can be recognized according to the time information. Thus, display of drawing information can be reproduced in the same way that actual drawing information was displayed, so that debugging can be performed more efficiently.

The drawing information storing step may includes the step of sending the drawing history data to a terminal connected to a network.

Therefore, the history data can be directly stored in a remote terminal used by a user for debugging. Thus, usability for performing debugging at a place far from the image forming apparatus can be improved.

A key operation reproducing method can be also provided, in which the key operation reproducing method is used for reproducing a key operation input from an operation panel in an image forming apparatus, the image forming apparatus comprising an application for performing a user service and the operation panel, the key operation reproducing method includes the steps of: obtaining key history data from a storage that stores the key history data, the key history data including a plurality of pieces of key event information corresponding to key operations on the operation panel; generating reproduced information from the key history data; and sending the reproduced information to the application so as to reproduce a key operation.

Accordingly, a key operation can be automatically reproduced and execution result of the key operation can be easily evaluated, so that debugging and evaluation can be performed efficiently.

The key history data includes key event information to which time information is added, and the reproduced information is sent to the application at time intervals on the basis of the time information.

Therefore, a series of key operations can be automatically reproduced at intervals same as those at which the key operations were actually performed. Thus, debugging and evaluation can be performed further efficiently.

The key operation reproducing method may includes the steps of:

obtaining drawing history data, from the storage, including a plurality of pieces of drawing information output to the operation panel; and

comparing first drawing information sent from the application by a key operation that is reproduced with second drawing information in the drawing history data; and

when the first drawing information differs from the second drawing information, notifying a user that the first drawing information differs from the second drawing information.

Accordingly, it can be automatically determined whether the drawing information displayed on the operation panel by the application is normal. Thus, debugging and evaluation can be performed further efficiently.

In the above-mentioned method, the image forming apparatus further may includes a system control service for sending the key event information to the application, the system control service being provided between the application and hardware resources used for image forming processes; and the reproduced information is sent to the application via the system control service.

Therefore, when the system control service sends the key event information to the application by actual key operation, reproduction of key operations conforms to actual operation.

The key operation reproducing method may includes the step of calling, to the system control service, a mode switching function for switching a mode of the image forming apparatus to a reproducing mode when a request for reproducing a key operation is issued, wherein only the reproduced information is accepted in the reproducing mode.

Since the reproducing mode is provided, a key operation that is unnecessary for reproducing key operations can be prevented from being input from the operation panel.

The request may be issued when a predetermined combination of keys is input from the operation panel.

In addition, the key operation reproducing may method further includes the step of executing a launching function, in the system control service, for launching a process for reproducing the key operation when the request is issued.

According to the above-mentioned method, it becomes unnecessary to restart the image forming apparatus when the key operation reproducing process is performed. Thus, usability for debugging can be improved.

In addition, the key operation reproducing method may further includes the steps of sending a stop request to the system control service when processing for reproducing key operations ends; and

wherein the system control service stops the process for reproducing key operations when the system control service receives the stop request.

Accordingly, the process for key monitoring can be automatically stopped when the key operation reproducing process ends. Thus, usability for debugging can be improved.

According to the present invention, the image forming apparatus and a computer program suitable for performing the above-mentioned methods can be provided. In the image forming apparatus, the key monitoring part and the key event storing part may operate as different processes, and the key history data is sent to the key event storing part by using interprocess communication between the key monitoring part and the key event storing part.

Thus, The key event storing part can be provided independent of the key monitoring part. Therefore, complication of the configuration of the key monitoring part can be avoided.

In addition, since the key event processing part may be a thread generated in a process of the key monitoring part, even when a key operation and other data processing are performed at a short time interval or at the same time, both of the key operation and the other data processing can be performed concurrently, so that debugging can be performed in the same situation as actual operation is performed. In addition, when the time information is added to the key event information, the time information does not differ from actual time.

The present invention is not limited to the specifically disclosed embodiments, and variations and modifications may be made without departing from the scope of the present invention.

What is claimed is:

1. A key operation monitoring method used for monitoring a key operation input from an operation panel in an image forming apparatus, said key operation monitoring method comprising:
a key monitoring step of obtaining said key operation as key event information.

2. The key operation monitoring method as claimed in claim 1; said key monitoring step comprising the step of receiving key event information sent by a communication driver in said operation panel.

3. The key operation monitoring method as claimed in claim 1, wherein said image forming apparatus comprises:
hardware resources used for image forming processes;
an application for performing a process specific for a user service; and
a system control service for controlling said operation panel, said system control service being provided between said application and said hardware resources;
said key monitoring step comprising the steps of:
obtaining said key operation as said key event information by said system control service; and
receiving said key event information from said system control service by using interprocess communication.

4. The key operation monitoring method as claimed in claim 3, said key operation monitoring method further comprising the key event storing step of storing a plurality of pieces of key event information in a storage as key history data.

5. The key operation monitoring method as claimed in claim 4, said key operation monitoring method further comprising the step of:
adding time information to said key event information; and
said key event storing step comprising the step of storing said key event information to which said time information is added in said storage as said key history data.

6. The key operation monitoring method as claimed in claim 4, said key operation monitoring method further comprising the step of:
sending said key history data to a terminal that is connected to a network.

7. A drawing information obtaining method used for obtaining drawing information output to an operation panel in an image forming apparatus, said image forming apparatus comprising an application for providing a user service and said operation panel, said drawing information obtaining method comprising:
the drawing information obtaining step of receiving said drawing information from said application by using interprocess communication.

8. The drawing information obtaining method as claimed in claim 7, said drawing information obtaining step comprising the step of:
receiving a call for a drawing information sending function from said application, said drawing information sending function corresponding to a function for managing said operation panel.

9. The drawing information obtaining method as claimed in claim 7, said drawing information obtaining method further comprising:
the drawing information storing step of storing a plurality of pieces of drawing information in a storage as drawing history data.

10. The drawing information obtaining method as claimed in claim 9, said drawing information obtaining method comprising the step of:
adding time information to said drawing information that is received; and
said drawing information storing step comprising the step of storing said drawing information to which said time information is added in said storage as said drawing history data.

11. The drawing information obtaining method as claimed in claim 9, said drawing information storing step comprising the step of:
sending said drawing history data to a terminal connected to a network.

12. A key operation reproducing method used for reproducing a key operation input from an operation panel in an image forming apparatus, said image forming apparatus comprising an application for performing a user service and said operation panel, said key operation reproducing method comprising the steps of:
obtaining key history data from a storage that stores said key history data, said key history data including a plurality of pieces of key event information corresponding to key operations on said operation panel;
generating reproduced information from said key history data; and
sending said reproduced information to said application so as to reproduce a key operation.

13. The key operation reproducing method as claimed in claim 12, wherein said key history data includes key event information to which time information is added, and said reproduced information is sent to said application at time intervals on the basis of said time information.

14. The key operation reproducing method as claimed in claim 12, said key operation reproducing method comprising the steps of:
obtaining drawing history data, from said storage, including a plurality of pieces of drawing information output to said operation panel; and
comparing first drawing information sent from said application by a key operation that is reproduced with second drawing information in said drawing history data; and
when said first drawing information differs from said second drawing information, notifying a user that said first drawing information differs from said second drawing information.

15. The key operation reproducing method as claimed in claim 12, wherein said image forming apparatus further comprising a system control service for sending said key event information to said application, said system control service being provided between said application and hardware resources used for image forming processes; and
wherein said reproduced information is sent to said application via said system control service.

16. The key operation reproducing method as claimed in claim 15, said key operation reproducing method comprising the step of:
calling, to said system control service, a mode switching function for switching a mode of said image forming apparatus to a reproducing mode when a request for reproducing a key operation is issued, wherein only said reproduced information is accepted in said reproducing mode.

17. The key operation reproducing method as claimed in claim 16, wherein said request is issued when a predetermined combination of keys is input from said operation panel.

18. The key operation reproducing method as claimed in claim 15, said key operation reproducing method further comprising the step of:
executing a launching function, in said system control service, for launching a process for reproducing said key operation when said request is issued.

19. The key operation reproducing method as claimed in claim 18, said key operation reproducing method further comprising the steps of:
sending a stop request to said system control service when processing for reproducing key operations ends; and
wherein said system control service stops said process for reproducing key operations when said system control service receives said stop request.

20. A computer readable medium storing program code for causing an image forming apparatus to monitor a key operation input from an operation panel in said image forming apparatus, said computer readable medium comprising:
key monitoring program code means for obtaining said key operation as key event information.

21. The computer readable medium as claimed in claim 20, said key monitoring program code means comprising program code means for receiving key event information sent by a communication driver in said operation panel.

22. The computer readable medium as claimed in claim 20, wherein said image forming apparatus comprises:
hardware resources used for image forming processes;
an application for performing a process specific for a user service; and
a system control service for controlling said operation panel, said system control service being provided between said application and said hardware resources;
said key monitoring program code means comprising:
program code means for obtaining said key operation as said key event information by using said system control service; and
program code means for receiving said key event information from said system control service by using interprocess communication.

23. A computer readable medium storing program code for causing an image forming apparatus to obtain drawing information output to an operation panel in said image forming apparatus, said image forming apparatus comprising an application for providing a user service and said operation panel, said computer readable medium comprising:
drawing information obtaining program code means for receiving said drawing information from said application by using interprocess communication.

24. A computer readable medium storing program code for causing an image forming apparatus to reproduce a key operation input from an operation panel in said image forming apparatus, said image forming apparatus comprising an application for performing a user service and said operation panel, said computer readable medium comprising:
program code means for obtaining key history data from a storage that stores said key history data, said key history data including a plurality of pieces of key event information corresponding to key operations on said operation panel;
program code means for generating reproduced information from said key history data; and
program code means for sending said reproduced information to said application so as to reproduce a key operation.

25. An image forming apparatus that provides a user service relating to image formation on the basis of a key operation from an operation panel, said image forming apparatus comprising:
said operation panel; and
a key monitoring part for obtaining said key operation as key event information.

26. The image forming apparatus as claimed in claim 25, wherein said key monitoring part receives said key event information sent by a communication driver for said operation panel.

27. The image forming apparatus as claimed in claim 25, further comprising:
hardware resources used for image forming processes;
an application for providing said user service; and
a system control service for controlling said operation panel, said system control service being provided between said application and said hardware resources;
wherein said system control service obtains said key operation as said key event information from said operation panel; and
wherein said key monitoring part receives said key event information from said system control service by using interprocess communication.

28. The image forming apparatus as claimed in claim 27, said image forming apparatus further comprising a key event storing part for storing a plurality of pieces of key event information in a storage as key history data.

29. The image forming apparatus as claimed in claim 28, said key operation monitoring part comprising a key event processing part for adding time information to said key event information that is received; and
wherein said key event storing part stores said key event information to which said time information is added in said storage as said key history data.

30. The image forming apparatus as claimed in claim 28, wherein said key event storing part sends said key history data to a terminal that is connected to a network.

31. The image forming apparatus as claimed in claim 28, wherein said key monitoring part and said key event storing part operate as different processes, and said key history data is sent to said key event storing part by using interprocess communication between said key monitoring part and said key event storing part.

32. The image forming apparatus as claimed in claim 29, wherein said key event processing part is a thread generated in a process of said key monitoring part.

33. An image forming apparatus that provides a user service relating to image formation on the basis of a key operation from an operation panel, said image forming apparatus comprising an application for providing said user service and said operation panel, said image forming apparatus further comprising:
a drawing information obtaining part for receiving drawing information that is output to said operation panel by said application, wherein said drawing information obtaining part receives said drawing information from said application by using interprocess communication.

34. The image forming apparatus as claimed in claim 33, wherein said drawing information obtaining part operates as a server process regarding said application as a client;
wherein said application includes an operation panel control service library in which a drawing information sending function corresponding to a function for controlling said operation panel is defined, and said application sends said drawing information to said drawing information obtaining part by executing said drawing information sending function.

35. The image forming apparatus as claimed in claim 33, said image forming apparatus further comprising:
a drawing information storing part for storing a plurality of pieces of drawing information in a storage as drawing history data.

36. The image forming apparatus as claimed in claim 35, said drawing information obtaining part comprising:
a drawing information processing part for adding time information to said drawing information that is received; and
wherein said drawing information storing part stores said drawing information to which said time information is added in said storage as said drawing history data.

37. The image forming apparatus as claimed in claim 35, wherein said drawing information storing part sends said drawing history data to a terminal connected to a network.

38. The image forming apparatus as claimed in claim 33, wherein said drawing information obtaining part and said drawing information storing part operate as different processes, and said drawing history data is sent to said drawing information storing part by using interprocess communication between said drawing information obtaining part and said drawing information storing part.

39. The image forming apparatus as claimed in claim 36, wherein said drawing information processing part is a thread generated in a process of said drawing information obtaining part.

40. An image forming apparatus for reproducing a key operation input from an operation panel, said image forming apparatus comprising an application for providing a user service relating to image formation and said operation panel, said image forming apparatus further comprising:
a storage for storing a plurality of pieces of key event information corresponding to key operations as key history data;
a reproducing part for generating reproduced information from said key history data, and sending said reproduced information to said application so as to reproduce a key operation.

41. The image forming apparatus as claimed in claim 40, wherein said key history data includes key event information to which time information is added, and said reproduced information is sent to said application at time intervals on the basis of said time information.

42. The image forming apparatus as claimed in claim 40, wherein said storage stores drawing history data including a plurality of pieces of drawing information output to said operation panel; and
said reproducing part compares first drawing information sent from said application by a key operation that is reproduced with second drawing information in said drawing history data; and
when said first drawing information differs from said second drawing information, said image forming apparatus notifies a user that said first drawing information differs from said second drawing information.

43. The image forming apparatus as claimed in claim 40, wherein said image forming apparatus further comprising a system control service for sending said key event information to said application, said system control service being provided between said application and hardware resources used for image forming processes; and
wherein said reproduced information is sent to said application via said system control service.

44. The image forming apparatus as claimed in claim 43, wherein said system control service includes a mode switching function for switching a mode of said image forming apparatus to a reproducing mode, wherein only reproduced information sent from said reproducing part is accepted in said reproducing mode; and
wherein said reproducing part calls, to said system control service, said mode switching function when a request for reproducing a key operation is issued.

45. The image forming apparatus as claimed in claim 44, said image forming apparatus further comprising a part for issuing said request when a predetermined combination of keys is input from said operation panel.

46. The image forming apparatus as claimed in claim 43, wherein said system control service includes a launching function for launching a process of said reproducing part, and executes said launching function when said request is issued.

47. The image forming apparatus as claimed in claim 46, wherein said reproducing part sends a stop request to said system control service when processing for reproducing key operations ends, and
wherein said system control service stops a process of said reproducing part when said system control service receives said stop request.
